(19) United States
(12) Patent Application Publication
(10) Pub. No.: US 2026/0320179 A1
(43) Pub. Date: Oct. 15, 2026

(54) DISPOSABLE EMAIL ADDRESS DETECTION AND TRACKING

(71) Applicant: Oracle International Corporation, Redwood Shores, CA (US)

(72) Inventors: Christopher Robert Baker, Nashua, NH (US); Jonathan Philip Taimanglo, Arlington, VA (US); Peter Martin Hanily, Dublin (IE); Ryan Daniel Schilcher, Seattle, WA (US)

(73) Assignee: Oracle International Corporation, Redwood Shores, CA (US)

(21) Appl. No.: 19/179,304

(22) Filed: Apr. 15, 2025

(51) Int. Cl. G06F 21/55

(52) U.S. Cl. CPC G06F 21/554; G06F 2221/034

(57) ABSTRACT

Techniques for detecting and tracking disposable email addresses are detected. A first email associated with a first domain and a second email associated with a second domain are received. The first domain and the second domain may be different. An analysis is performed on a plurality of DNS (domain name system) records comprising at least a first DNS record of a first type associated with the first email and a second DNS record of a second type associated with the second email. The first type and the second type are different. Whether a correlation of information amongst the plurality of DNS records satisfies a security criterion is determined. In an example, responsive to (1) determining that the first domain has been flagged as malicious and (2) determining that the correlation of information amongst the plurality of DNS records satisfies the security criterion, the second domain is flagged as malicious.

### BACKGROUND

Electronic mail or email have become ubiquitous in today's society, and are used for a plethora of applications. For example, in addition to being used for communication between two users, emails are often used to open accounts with service providers. For example, one email account may be used to open a corresponding account with a specific service provider.

### BRIEF SUMMARY

In various embodiments, a non-transitory computer-readable medium includes instructions that when executed by one or more processors, cause a system including the one or more processors to perform operations including: receiving a first email associated with a first domain and a second email associated with a second domain, wherein the first domain and the second domain are different; performing an analysis on a plurality of DNS (domain name system) records comprising at least a first DNS record of a first type associated with the first email and a second DNS record of a second type associated with the second email, wherein the first type and the second type are different; based on the analysis, determining whether a correlation of information amongst the plurality of DNS records satisfies a security criterion; and responsive to (1) determining that the first domain has been flagged as malicious and (2) determining that the correlation of information amongst the plurality of DNS records satisfies the security criterion, flagging the second domain as malicious.

In an example, each of the plurality of DNS records comprises a mapping between a respective input data and a respective output data; the output data of the first DNS record of the first type comprises a first Internet Protocol (IP) address; the output data of the second DNS record of the second type does not comprise any IP address; the operations further comprise identifying the plurality of DNS records for analysis, wherein identifying the plurality of DNS records comprises: setting the second domain name as a current input data; iteratively performing: identifying a DNS record, from the plurality of DNS records, that has a respective input data matching the current input data; identifying a respective output data corresponding to the respective input data based on the DNS record; and setting the respective output data as the current input data, until the respective output data comprises a second IP address; and determining whether the correlation of information amongst the plurality of DNS records satisfies the security criterion comprises: determining whether the first IP address and the second IP address match.

In an example, each of the plurality of DNS records comprises a mapping between a respective input data and a respective output data; the output data of the first DNS record of the first type comprises a first mail server identifier; the output data of the second DNS record of the second type does not comprise any mail server identifier; the operations further comprise identifying the plurality of DNS records for analysis, wherein identifying the plurality of DNS records comprises: setting the second domain name as a current input data; iteratively performing: identifying a DNS record, from the plurality of DNS records, that has a respective input data matching the current input data; identifying a respective output data corresponding to the respective input data based on the DNS record; and setting the respective output data as the current input data, until the respective output data comprises a second mail server identifier; and determining whether the correlation of information amongst the plurality of DNS records satisfies the security criterion comprises: determining whether the first mail server identifier and the second mail server identifier match.

In an example, the first DNS record of the first type comprises a first MX record identifying a first mail server identifier associated with the first domain, wherein the first mail server is associated with a first Internet Protocol (IP) address; the second DNS record of the second type comprises a first A record or a first AAAA record identifying a second IP address associated with a second mail server identifier that is associated with the second domain; and determining that the correlation of information amongst at least the first DNS record and the second DNS record satisfies the security criterion is responsive at least to determining that the first IP address and the second IP address match.

In an example, each of the plurality of DNS records comprises a mapping between a respective input data and a respective output data; the operations further comprise identifying the plurality of DNS records for analysis, wherein identifying the plurality of DNS comprises: setting the first domain name as a current input data; iteratively performing, until an end criterion is satisfied: identifying a DNS record, from the plurality of DNS records, that has a respective input data matching the current input data; identifying a respective output data corresponding to the respective input data based on the DNS record; setting the respective output data as the current input data; determining whether the correlation of information amongst the plurality of DNS records satisfies the security criterion comprises: calculating a correlation score for the plurality of DNS records. In an example, the end criterion comprises the respective output data corresponding to the respective input data based on the DNS record being an internet protocol (IP) address. In an example, the end criterion comprises iteratively performing for at least a threshold number of times.

In an example, determining whether the correlation of information amongst the plurality of DNS records satisfies the security criterion comprises: applying a machine-learning model to the plurality of DNS records to determine whether the security criterion is satisfied. In an example, the first DNS record of the first type comprises one of an A record, an AAAA record, a MX record (mail exchanger record), and a NS (nameserver) record; and the second DNS record of the second type comprises another of the A record, the AAAA record, the MX record, and the NS record. In an example, the security criterion comprises a correlation score for the plurality of DNS records being above a threshold score. In an example, a malicious flag on the second domain indicates that the second domain is likely used for disposable email addresses. In an example, the operations further include: granting access to one or more services to a first user associated a third email associated with a third domain that has not been flagged as malicious; and denying the one or more services to a second user associated with the second email associated with the second domain based at least on flagging that the second domain as malicious.

In various embodiments, a method comprises: receiving a first email associated with a first domain and a second email associated with a second domain, wherein the first domain and the second domain are different; performing an analysis on a plurality of DNS (domain name system) records comprising at least a first DNS record of a first type associated with the first email and a second DNS record of a second type associated with the second email, wherein the first type and the second type are different; based on the analysis, determining whether a correlation of information amongst the plurality of DNS records satisfies a security criterion; and responsive to (1) determining that the first domain has been flagged as malicious and (2) determining that the correlation of information amongst the plurality of DNS records satisfies the security criterion, flagging the second domain as malicious. In an example, each of the plurality of DNS records comprises a mapping between a respective input data and a respective output data; the output data of the first DNS record of the first type comprises a first Internet Protocol (IP) address; the output data of the second DNS record of the second type does not comprise any IP address; the method further comprises identifying the plurality of DNS records for analysis, wherein identifying the plurality of DNS records comprises: setting the second domain name as a current input data; iteratively performing: identifying a DNS record, from the plurality of DNS records, that has a respective input data matching the current input data; identifying a respective output data corresponding to the respective input data based on the DNS record; and setting the respective output data as the current input data, until the respective output data comprises a second IP address; and determining whether the correlation of information amongst the plurality of DNS records satisfies the security criterion comprises: determining whether the first IP address and the second IP address match.

In an example, each of the plurality of DNS records comprises a mapping between a respective input data and a respective output data; the output data of the first DNS record of the first type comprises a first mail server identifier; the output data of the second DNS record of the second type does not comprise any mail server identifier; the method further comprises identifying the plurality of DNS records for analysis, wherein identifying the plurality of DNS records comprises: setting the second domain name as a current input data; iteratively performing: identifying a DNS record, from the plurality of DNS records, that has a respective input data matching the current input data; identifying a respective output data corresponding to the respective input data based on the DNS record; and setting the respective output data as the current input data, until the respective output data comprises a second mail server identifier; and determining whether the correlation of information amongst the plurality of DNS records satisfies the security criterion comprises: determining whether the first mail server identifier and the second mail server identifier match. In an example, the first DNS record of the first type comprises a first MX record identifying a first mail server identifier associated with the first domain, wherein the first mail server is associated with a first Internet Protocol (IP) address; the second DNS record of the second type comprises a first A record or a first AAAA record identifying a second IP address associated with a second mail server identifier that is associated with the second domain; and determining that the correlation of information amongst at least the first DNS record and the second DNS record satisfies the security criterion is responsive at least to determining that the first IP address and the second IP address match.

In an example, the first DNS record of the first type comprises one of an A record, an AAAA record, a MX record (mail exchanger record), and a NS (nameserver) record; and the second DNS record of the second type comprises another of the A record, the AAAA record, the MX record, and the NS record. In an example, the method further comprises: granting access to one or more services to a first user associated a third email associated with a third domain that has not been flagged as malicious; and denying the one or more services to a second user associated with the second email associated with the second domain based at least on flagging that the second domain as malicious.

In various embodiments, a system comprises: one or more processors; and one or more non-transitory computer-readable media storing instructions, which, when executed by the system, cause the system to perform a set of actions including: receiving a first email associated with a first domain and a second email associated with a second domain, wherein the first domain and the second domain are different; performing an analysis on a plurality of DNS (domain name system) records comprising at least a first DNS record of a first type associated with the first email and a second DNS record of a second type associated with the second email, wherein the first type and the second type are different; based on the analysis, determining whether a correlation of information amongst the plurality of DNS records satisfies a security criterion; and responsive to (1) determining that the first domain has been flagged as malicious and (2) determining that the correlation of information amongst the plurality of DNS records satisfies the security criterion, flagging the second domain as malicious. In an example, a malicious flag on the second domain indicates that the second domain is likely used for disposable email addresses.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a disposable email address detection and tracking service that detects and tracks disposable email addresses having varying domain names, and/or detects and tracks domain names offering disposable email addresses.

FIGS. 2A, 2B, and 2C illustrate various example MX (mail exchanger) records corresponding to various domain names.

FIG. 3 illustrates a plurality of “A” records for various example mail servers.

FIG. 4 illustrates a plurality of NS records for various example domain names.

FIGS. 5A, 5B, and 5C illustrate a system that determines whether an email address is a disposable email address, and whether a corresponding domain name is associated with disposable email addresses.

FIGS. 6A, 6B, 6C, 6D, and 6E illustrate correlation examples between (i) first DNS records associated with a first email from a first email address from a first domain and (ii) second DNS records associated with a second email from a second email address from a second domain.

FIGS. 7A and 7B illustrate flowcharts depicting methods for determining whether an email address is likely to be a disposable email address and whether an email domain offers disposable email addresses.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

Disposable email addresses may be used by threat actors for various malicious purposes. For example, when signing up for an account with a service provider, a user may have to provide an email address to the service provider. The service provider may be any type of service provider, such as a provider of cloud services, an e-commerce service provider, a social networking website, or any provider of any type of service(s) over the Internet. Often times, service providers seek to limit the number of accounts or resources a single individual can have, e.g., by asking for a unique email address for each account or resource the individual is to use.

Accordingly, a single actor may use multiple email addresses (such as hundreds, or thousands, or even more) to sign up for multiple accounts and/or resources with the service provider. For example, account farmers use multiple email addresses to sign up for multiple accounts and/or resources with the service provider, and then exploit the farmed accounts and/or resources for possibly malicious purposes.

Opening such a large number of email addresses with a reputed email provider (e.g., Gmail™ or Yahoo™) may be time and/or resource consuming, as a reputed email provider may want to validate a user trying to open an email account, such as validating a user using his or her phone number, or other forms of identification (such as driver license, or a credit card). Accordingly, use of large number of burner or disposable email accounts from a reputed email provider for malicious purposes by a threat actor may be limited.

In an example, instead of using a reputed email provider, threat actors or threat organizations may develop tooling and infrastructure that simplifies creating many new email addresses associated with a number of different domain names. For example, a user can access a website and create multiple email addresses with many different domain names from the same website. For example, from a single website, the threat actor can open disposable email addresses having the domain names good81hotel.com, best81hotel.com, and awesome81hotel.com to be used for possibly malicious purposes in the hospitality sector. Websites offering disposable email addresses from multiple domain names exist today, and can be easily found using simple web search. Although such disposable email addresses can be used for some legitimate use cases, malicious use of such disposable email addresses may be possible and is frequently observed.

Accordingly, techniques are disclosed herein to detect and track disposable email addresses, as well as detect and track email providers and domains providing disposable email addresses, and undertake mitigating actions based on such tracking. For example, a disposable email detection and tracking service 104 may perform such detection and tracking. The disposable email detection and tracking service 104 may be deployed by organizations, entities, providers of cloud environments, etc., who may offer services for which users can subscribe using disposable emails, and/or who may otherwise be adversely affected by or have interest in detecting and tracking malicious use of disposable email addresses.

For example, assume the above example where a single disposable email address provider provides disposable email addresses for example domains good81hotel.com and best81hotel.com. For example, the single and common disposable email address provider uses at least in part a common infrastructure (such as a common mail server, a common authoritative DNS (domain name system) server, etc.) to provide email services to email addresses from such multiple domains good81hotel.com and best81hotel.com.

Also assume that the disposable email detection and tracking service 104 is aware that a first domain good81hotel.com provides disposable email address. For example, assume that the disposable email detection and tracking service 104 has received a first email from a first email address with the first domain name good81hotel.com, and the disposable email detection and tracking service 104 knows a-priori that the first email address is a disposable email address and that the first domain good81hotel.com offers disposable email addresses. Now assume that the disposable email detection and tracking service 104 receives a second email having a second address with the domain name best81hotel.com. The disposable email detection and tracking service 104 does not know a-priori as to whether the second email address from the domain best81hotel.com is a disposable email address. However, using techniques described herein, the disposable email detection and tracking service 104 can detect whether the second email address is also a disposable email address and whether the domain best81hotel.com also offers disposable email addresses, e.g., based on the prior knowledge that the domain good81hotel.com offers disposable email addresses.

For example and as will be described below in further detail, the disposable email detection and tracking service 104 receives first one or more DNS records for the first email address associated with the first domain good81hotel.com (which is known to provide disposable email addresses). The disposable email detection and tracking service 104 also receives second one or more DNS records for the second email address associated with the second domain best81hotel.com (it is unknown at this point as to whether the domain provides disposable email addresses). Various types of DNS records have been described below in further detail, such as “A” or AAAA records, MX (mail exchanger) records, NS (nameserver) records, CNAME (Canonical Name) records, etc.

The disposable email detection and tracking service 104 detects whether a correlation between the first one or more DNS records and the second one or more DNS records satisfies a security criteria. For example, because the common disposable email provider owns and/or operates both the domains best81hotel.com and good81hotel.com, the common disposable email provider may use common technical resource (such as a common mail server) to service these two domains. The disposable email detection and tracking service 104 tries to find, by correlating the first and second DNS records, whether there is a positive correlation between the first and second DNS records.

In an example, the disposable email service provider may try to obfuscate discovery of common ownership and/or common operation of the two domains by the same disposable email service provider. For example, to reduce chances of such discovery, the disposable email service provider may use different identifiers (or names) for the email servers of the first domain and the second domain. Accordingly, a first MX record (described below in further detail) associated with the first email address has a first identifier of a first mail server for the first domain, and a second MX record associated with the second email address has a second identifier of a second mail server for the second domain, and the disposable email service provider may keep (e.g., with or without malicious intent) the first and second identifiers different. For example, although the first mail server and the second mail server may be the same mail server (e.g., the two mail server identifiers may point to the same IP address of the common or single mail server), the disposable email service provider may uses aliases, such as different first identifier of the first mail server and second identifier of the second mail server. Thus, merely from the first and second MX records, it may not be possible to detect common ownership and/or common operator of the first and second domains.

Accordingly, in an example, the disposable email detection and tracking service 104 fetches the A or AAAA records (also described below in further detail) that includes IP (internet protocol) addresses of the first mail server and the second mail server. Now, in an example, because the first mail server identifier and the second mail server identifier are aliases of the same underlying mail server, the IP addresses corresponding to the first mail server identifier and the second mail server identifier would match. This provides an indication that the first domain and the second domain are commonly owned and/or commonly operated. Also, the first domain is know a-priori to offer disposable email addresses. Accordingly, it may be inferred that the second domain is also likely to offer disposable email addresses, and the corresponding second email address is also likely a disposable email address. Numerous other techniques, embodiments, and examples to detect and track disposable email addresses and domains offering such disposable email addresses are also described below in further detail.

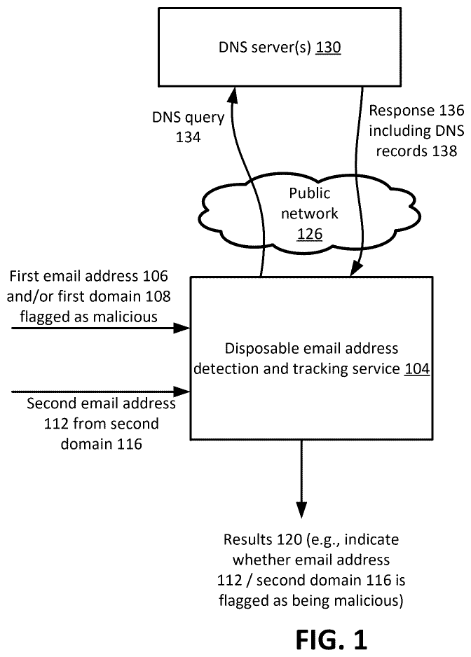

FIG. 1 illustrates a block diagram of a disposable email address detection and tracking service 104 that detects and tracks disposable email addresses having varying domain names, and/or detects and tracks domain names offering disposable email addresses. In an example, multiple disposable email addresses may be offered by an email service provider to a single user. In an example, a user may sign up for multiple disposable email addresses offered by the same organization, with the organization being aware of the large number of such disposable email addresses being assigned to the same user. In an example, a user may not have to undergo through a complete and/or unique verification process (such as verification of a unique phone number) each time the user has to sign up for a disposable email address. Thus, a user can sign up for a large number of disposable email addresses with relative ease (e.g., compared to a scenario where a user aims to open multiple such email addresses with a reputed email service provider such as Google® or Yahoo®).

In an example, a legitimate user may use such disposable email addresses for legitimate purposes, such as using a unique email address for each contact or entity, or using a unique email address for a limited number of times, for a limited number of uses, and/or for a limited time period. Thus, if an email address is compromised or utilized in connection with email abuse (or if the user wants to use the email for a limited number of times or uses, or a limited time period), the user can simply cancel or “dispose” of the email address, without affecting the whole email address ecosystem of the user. Thus, disposable emails can be used for various legitimate purposes.

However, as described above, disposable email addresses can be used for anomalous or malicious purposes as well. For example, disposable email addresses may often be used by threat actors. For example, when signing up for an account with a service provider, a user may have to provide an email address to the service provider. The service provider may be any type of service provider, such as a provider of cloud services, an e-commerce service provider, a social networking website, or any provider of any type of service(s) over the Internet. Often times, service providers seek to limit a number of accounts or resources a single individual can have, e.g., by asking for a unique email address for each account or resource the individual is to use. Accordingly, a single actor may use multiple email addresses (such as tens, or hundreds, or thousands, or even more) to sign up for multiple accounts and/or resources with the service provider. For example, account farmers use multiple email addresses to sign up for multiple accounts and/or resources with the service provider, and then exploit the farmed accounts and/or resources for possibly malicious or anomalous purposes.

In an example, instead of using a reputed email provider, threat actors or threat organizations may utilize disposable email addresses provided by providers of disposable email addresses, which provides tooling and infrastructure that simplifies creating many new email addresses associated with a single domain name and/or a number of different domain names. Websites offering disposable email addresses from multiple domain names exist today, and can be easily found using simple a web search. For example, a user can access a website of a disposable email address provider, and create multiple email addresses with a single or many different domain names. For example, from a single website, the threat actor can open disposable email addresses having the domain names good81hotel.com and/or best81hotel.com, to be used for possibly malicious purposes in the hospitality sector. Thus, the threat actor may open email accounts with email addresses of abc@good81hotel.com, abc1@good81hotel.com, abc2@good81hotel.com, abc@best81hotel.com, abc1@best81hotel.com, abc2@best81hotel.com, and so on, where abc, abc1, etc. symbolically represents character string of usernames selected by the threat actor. Thus, the threat actor can open disposable email accounts for multiple domain names offered by the disposable email address provider.

Note that the various domain names discussed herein are mere examples, and matching of any example domain names used herein with actual domain names in the real world are merely coincidental, without any intent to malign such domain names or to allege that such domain names actually offer disposable email addresses.

In an example, a single disposable email address provider may have registered multiple domain names (such as good81hotel.com, best81hotel.com, and possible one or more other domain names, such as awesome81hotel.com, 81hotel.com, hotel81.com, etc.). The disposable email address provider may use any of such domain names for offering disposable email addresses to their clients, which may include legitimate users and possibly threat actors.

Referring again to FIG. 1, the disposable email address detection and tracking service 104 receives a first email from a first email address 106 associated with a first domain 108, where the first email address 106 and/or the first domain 108 are flagged as malicious. For example, the first email address 106 may be flagged as a disposable email address, and/or the first domain 108 may be flagged as a domain name of disposable email addresses. Merely as an example, the first email address 106 and/or the first domain 108 associated with the first email address 106 may be abc@good81hotel.com and good81hotel.com, respectively. Thus, the disposable email address detection and tracking service 104 is aware that the good81hotel.com is a domain name of disposable email addresses. Accordingly, in future, any email from good81hotel.com may also be flagged as being anomalous or possibly malicious by the disposable email address detection and tracking service 104.

In an example, the flagging of the first email address 106 and the first domain 108 may be performed in the past by the disposable email address detection and tracking service 104, by another component that detects disposable email addresses, performed manually by a security personal or security agency, or many be performed manually or automatically by another entity. Thus, an assumption is made here about a-priori knowledge regarding the first email address 106 and the first domain 108 being flagged as possibly being malicious (e.g., is a disposable email address and associated with disposable email addresses, respectively).

Now, the disposable email address detection and tracking service 104 receives a second email with a second email address 112 from a second domain name 116. The second domain name 116 may or may not match with the first domain name 108. The disposable email address detection and tracking service 104 aims to determine whether the second email address 112 of the second email from the second domain name 116 is also a disposable email address, and whether the second domain name 116 is a provider of disposable email addresses.

In an example, if the second domain name 116 and the first domain name 108 matches (e.g., the originating second email address 112 of the second email is xyz@good81hotel.com), then the disposable email address detection and tracking service 104 compares the second domain name 116 of the second email address 112 with that of the first domain name good81hotel.com that is known to provide disposable email addresses. Based on such a match, the disposable email address detection and tracking service 104 also flags the second email as being a disposable email, and flags the corresponding second email address 112 as being a disposable email address.

However, the second domain name 116 and the first domain name 108 may not match, but it may still be possible that a same disposable email address service provider provides disposable emails addresses with the second domain name 116 and the first domain name 108. Merely as an example, the second email address 112 may be xyz@best81hotel.com. Now the domain name best81hotel.com of the second email address 112 does not match with the first domain name 108 that is flagged as possibly being malicious. In an example, the disposable email address detection and tracking service 104 determines whether the second domain name 116 (e.g., best81hotel.com) is likely also associated with disposable emails, and accordingly, determines whether the second email address 112 is also a disposable email address. For example, the disposable email detection and tracking service 104 aims to determine whether a same disposable email address provider owns and/or operates both the second domain name 116 and the first domain name 108. If the disposable email detection and tracking service 104 determines that the second domain name 116 and the first domain name 108 are likely to be operated by the same entity (such as the same disposable email address provider), the disposable email detection and tracking service 104 infers that the second domain name 116 may also be associated with disposable email addresses.

The disposable email address detection and tracking service 104 outputs results 120, which provides an indication as to whether the second email address 112 and/or the second domain name 116 are flagged as possibly being malicious.

In an example, the disposable email address detection and tracking service 104 communicates with a DNS (domain name system) server 130 over a public network 126, such as the Internet. For example, the disposable email address detection and tracking service 104 transmits a DNS query 134 to the DNS server 130 over the public network 126, and receives a response 136 including one or more DNS records 138.

A DNS query is a request sent from a client (such as a web browser, a computer, a mobile phone) to a DNS server, e.g., to receive DNS records associated with a domain name, and/or to resolve a domain name into an Internet Protocol (IP) address. In the example of FIG. 1, the disposable email address detection and tracking service 104 is the client transmitting the DNS query 134 to the DNS server 130.

For example, when the disposable email address detection and tracking service 104 receives the second email from the second email address 112 from the second domain name 116, the disposable email address detection and tracking service 104 has to find out an IP address and/or other DNS records associated with the second domain name 116. The disposable email address detection and tracking service 104 checks a local DNS cache to see whether the IP address is cached within the local cache. If the IP address is not cached within the local cache, a DNS query (such as the lookup request 134) is sent to a DNS resolver, which is usually provided by an Internet Service Provider (ISP) or a public DNS service. The DNS resolver checks its own cache to see if the corresponding IP address is cached within its own cache. If the IP address is not cached by the DNS resolver, the DNS resolver may contact a root DNS server and/or a TLD (Top-Level Domain) server (e.g., .com, .org, .net servers). The root DNS server and/or the TLD respond with the address of an authoritative DNS server for the domain. The DNS resolver contacts the authoritative DNS server specific to the domain name of the website address or the email address. For example, if the email address has the domain name of best81hotel.com, the DNS query is routed to the authoritative DNS server for the domain name best81hotel.com. Thus, the DNS query raised by the disposable email address detection and tracking service 104 is routed to the DNS server 130, which may be an authoritative DNS server and/or an email server.

The authoritative DNS server maintains IP addresses and/or other DNS records corresponding to domain names. The authoritative DNS server is a final holder of an IP addresses and/or DNS records of the domain being queried for during a DNS lookup.

Note that as described above, a disposable email address provider may provide and operate disposable email addresses from multiple domain names, such as good81hotel.com and best81hotel.com. Because the same entity provides the multiple domain names and to conserve cost and/or technical complexity, a single or common authoritative DNS server may provide DNS lookup service for such multiple domain names. For example, the two domain names described above good81hotel.com and best81hotel.com may have a common authoritative DNS server (such as the DNS server 130), which may be, merely as an example, disposable_email.com. Thus, in this example, good81hotel.com and best81hotel.com may be domain aliases of disposable_email.com. Thus, a same disposable email address provider having the authoritative DNS server of disposable_email.com may provide email addresses for multiple domain names, such as for domain names good81hotel.com and best81hotel.com. Additionally or alternatively, in another example, the two domain names described above good81hotel.com and best81hotel.com may have a common mail server. Additionally or alternatively, in another example, the two domain names described above good81hotel.com and best81hotel.com may have respective names of their mail servers, but with a common IP address.

DNS records may change with time (e.g., due to change of IP addresses, change in ownership of domain names, etc.). A passive DNS database is a database of past or historic DNS query information. For example, although the mapping between a domain name and a corresponding IP address can become stale with time, the passive DNS database stores all such historic mapping information that were recorded in the past, or within a threshold period of time in the past.

DNS records are instructions stored on authoritative DNS servers (such as the DNS server 130) that help route traffic such as emails in a network. Different types of DNS records include “A” or AAAA records, MX (mail exchanger) records, NS (nameserver) records, CNAME (Canonical Name) records, etc. Various types of DNS records are described below.

A MX record is a type of a DNS record. A MX record specifies a mail server responsible for accepting email messages on behalf of a domain name. Thus, a MX record maps a domain name to one or more mail servers. The MX record may be a resource record in the DNS. For a given domain name, an array of mail servers may be possible (e.g., for load balancing and redundancy), and the MX record may identify such an array of mail servers. Thus, in DNS, MX records point to mail servers.

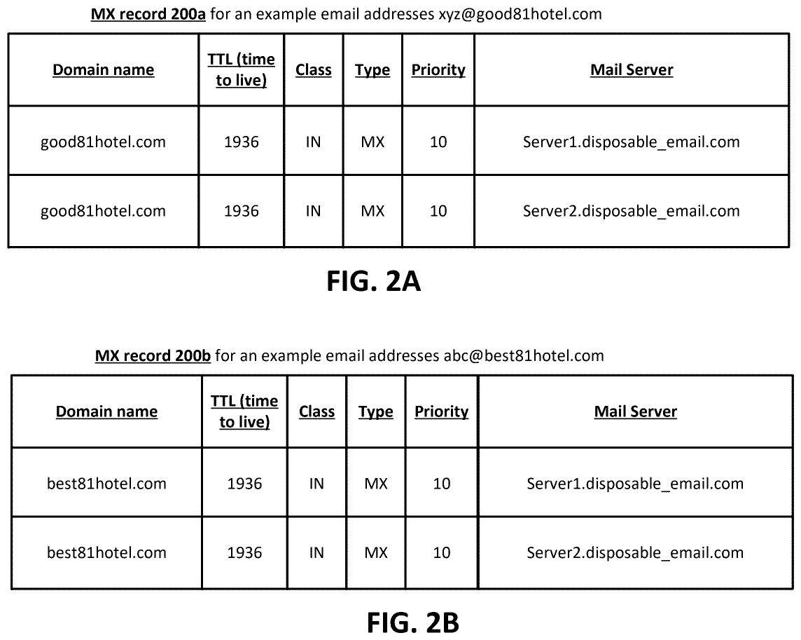

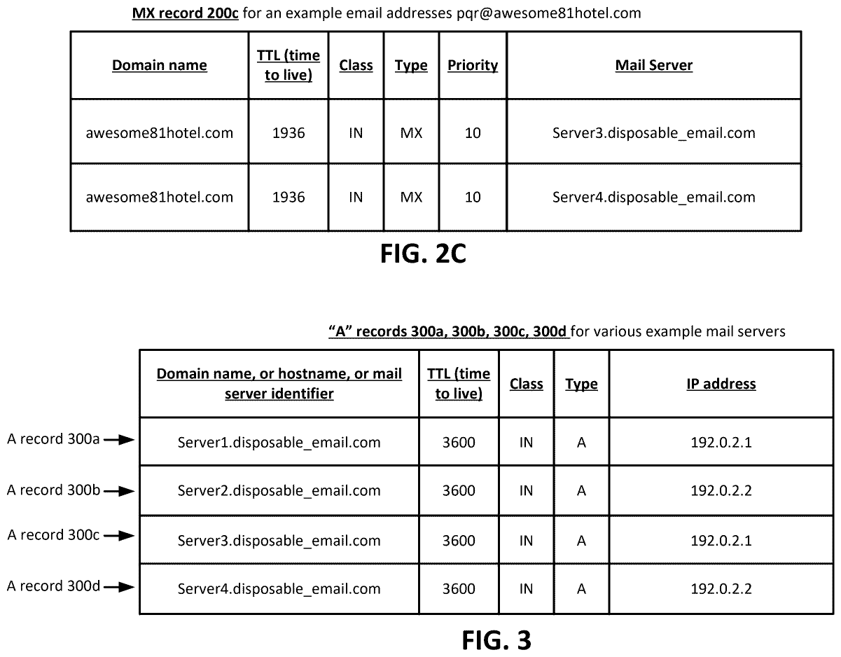

FIG. 2A illustrates an example MX Record 200a for an example email addresses xyz@ good81hotel.com, where xyz can be any appropriate string representing a username of an email address. Thus, the MX record 200a is for the domain good81hotel.com. For example, upon receiving an email from an email addresses xyz@good81hotel.com (e.g., having the domain name of good81hotel.com), the disposable email address detection and tracking service 104 queries a DNS server (such as the DNS server 130) about the domain good81hotel.com, and receives the MX record 200a of FIG. 2A. The queried DNS server is an authoritative DNS server for the domain good81hotel.com.

The MX record 200a has two rows corresponding to two mail servers for the domain name good81hotel.com. Although the domain good81hotel.com is assumed to have two mail servers in FIG. 2A, the domain good81hotel.com may include another appropriate number of amil servers. The second column of the MS record 200a includes TTL (time to live), which is a duration (e.g., in seconds) that this MS record is cached by DNS servers before the MX record 200a has to be refreshed. In the example of FIG. 2A, the TTL is 1936 seconds.

The third column of the MX record 200a indicates a record class, which is IN (Internet), thereby indicating that this applies to the internet. The fourth column of the MX record 200a indicates a type of the DNS record, which is an MX record. The fifth column of the MX record 200a indicates a priority of each mail server, which indicates the preference order of the mail servers. Lower numbers indicate higher priority. Both mail servers in the MX record 200a have an equal priority of 10 (merely as an example), meaning they have equal preferences. The last column of the MX record 200a indicates the two mail server identifiers (such as mail server names), which are Server1.disposable_email.com and Server2.disposable_email.com, merely as examples.

FIG. 2B illustrates another example MX Record 200b for another example email addresses abc@best81hotel.com, where abc can be any appropriate string representing a username of an email address. Thus, the MX record 200b is for the domain best81hotel.com. For example, upon receiving an email from an email addresses abc@best81hotel.com (e.g., having the domain name of best81hotel.com), the disposable email address detection and tracking service 104 queries a DNS server about the domain name best81hotel.com, and receives the MX record 200b of FIG. 2B. The queried DNS server is an authoritative DNS server for the domain best81hotel.com.

Thus, the first column of the MX record 200b indicates the domain name best81hotel.com. The second, third, fourth, and fifth columns of the MX record 200b are self-explanatory, e.g., based on the discussion with respect to the MX record 200a herein above. Although the entries in these columns and for the two MX records 200a and 200b are the same in the example of FIGS. 2A and 2B, they may not be the same in some other examples.

In the example of FIG. 2B, the last column of the MX record 200b indicates the two mail server identifiers, which are in this example Server1.disposable_email.com and Server2.disposable_email.com. Thus, in the example of FIG. 2B, the mail server identifiers Server1.disposable_email.com and Server2.disposable_email.com of the MX record 200b match with the mail server identifiers Server1.disposable_email.com and Server2.disposable_email.com of the MX record 200a of FIG. 2A. Thus, in this example, the two domains good81hotel.com and best81hotel.com are co-owned and/or co-operated by a same disposable email address provider, and shares the same mail server identifiers.

FIG. 2C illustrates another example MX Record 200c for another example email addresses pqr@awesome81hotel.com, where pqr can be any appropriate string representing a username of an email address. Thus, the MX record 200c is for the domain awesome81hotel.com. For example, upon receiving an email from an email addresses pqr@awesome81hotel.com (e.g., having the domain name of awesome81hotel.com), the disposable email address detection and tracking service 104 queries a DNS server (such as the DNS server 130) about the domain name awesome81hotel.com, and receives the MX record 200c of FIG. 2C. The queried DNS server is an authoritative DNS server for the domain awesome81hotel.com.

The first column of the MX record 200c indicates the domain name awesome81hotel.com. The second, third, fourth, and fifth columns of the MX record 200c are self-explanatory, e.g., based on the discussion with respect to the MX record 200a herein above. Although the entries in these columns and for the two MX records 200a and 200c are the same in the example of FIGS. 2A and 2C, they may not be the same in some other examples.

In the example of FIG. 2C, the last column of the MX record 200c indicates the two mail server identifiers, which are in this example Server3.disposable_email.com and Server4.disposable_email.com. Assume that the domain names good81hotel.com, best81hotel.com, and awesome81hotel.com are both registered to and/or operated by the same disposable email address provider. However, to obfuscate DNS records and in an attempt to coverup the fact that the fact that good81hotel.com and awesome81hotel.com are all registered to the same disposable email address provider and/or for other legitimate business or technical reasons, the mail servers for the good81hotel.com in FIG. 2A are named differently from the mail servers for the awesome81hotel.com in FIG. 2C. This results in further complicacies in detecting (e.g., by the disposable email address detection and tracking service 104) that email addresses associated with the two domain names good81hotel.com and awesome81hotel.com are offered by the same disposable email address provider. This in turn results in further complicacies in correlating (e.g., by the disposable email address detection and tracking service 104) the two domain names good81hotel.com and awesome81hotel.com.

Similar to the MX records, “A” records and AAAA records are types of DNS records. Note that in some instance herein the letter “A” in “A” records is displayed within double quotation marks, to better differentiate this term from the ordinary meaning of this letter in English language.

An “A” record translates a domain name, a hostname, or a mail server identifier to a corresponding IP address. Similarly, an AAAA record also translates a domain name, a hostname, or a mail server identifier to an IP address. “A” records are used to translate to IPv4 addresses, while AAAA records are used to translate to IPv6 addresses. Thus, depending on a type of the IP address (e.g., IPV4 or IPV6 address), the A or AAAA record maps to a corresponding IP address.

FIG. 3 illustrates a plurality of “A” records 300a, 300b, 300c, 300d for various example mail servers. Four “A” records are this illustrated in four rows of the table of FIG. 3. Note that the disposable email address detection and tracking service 104 may query the DNS server 130 four different instances, to receive the corresponding four “A” records. Although the four example “A” records are separate from each other and received in four different instances, these records are illustrated in a single table format for purposes of ease of identification.

The first column in FIG. 3 represents a domain name, or a hostname, or a mail server identifier. The “A” record 300a is for the mail server identifier Server1.disposable_email.com corresponding to the domains good81hotel.com and best81hotel.com. The “A” record 300b is for the mail server identifier Server2.disposable_email.com corresponding to the domains good81hotel.com and best81hotel.com. The “A” record 300c is for the mail server identifier Server3.disposable_email.com corresponding to the domain awesome81hotel.com. Finally, the “A” record 300d is for the mail server identifier Server4.disposable_email.com corresponding to the domain awesome81hotel.com.

As described above, in an example, all three domains good81hotel.com, best81hotel.com, and awesome81hotel.com are registered to the same disposable email address provider, and the same disposable email address provider operates the three domains and provides the email addresses associated with these three domains. However, as described above with respect to FIGS. 2A, 2B, and 2C, while the mail servers associated with the domains good81hotel.com and best81hotel.com may be named the same, the mail servers associated with the domain awesome81hotel.com are named differently. However, as illustrated in FIG. 3, these mail servers share same IP addresses.

Thus, in the example of FIG. 3, as indicated by the “A” records 300a and 300c, the mail server Server1.disposable_email.com and the mail server Server3.disposable_email.com have the same IP address of 192.0.2.1. Similarly, as indicated by the “A” records 300 b and 300 d, the mail server Server2.disposable_email.com and the mail server Server4.disposable_email.com have the same IP address of 192.0.2.2. This is because all these domains are owned and/or operated by the same disposable email address provider.

Thus, in this example, (i) the mail server Server1.disposable_email.com associated with the domains good81hotel.com and best81hotel.com and (ii) the mail server Server3.disposable_email.com associated with the domain awesome81hotel.com are named differently (as indicated by their MX records), but they are the same server and have the same IP address (as indicated by their A records). Similarly, (i) the mail server Server2.disposable_email.com associated with the domains good81hotel.com and best81hotel.com and (ii) the mail server Server4.disposable_email.com associated with the domain awesome81hotel.com are named differently (as indicated by their MX records), but are the same server and have the same IP address (as indicated by their A records).

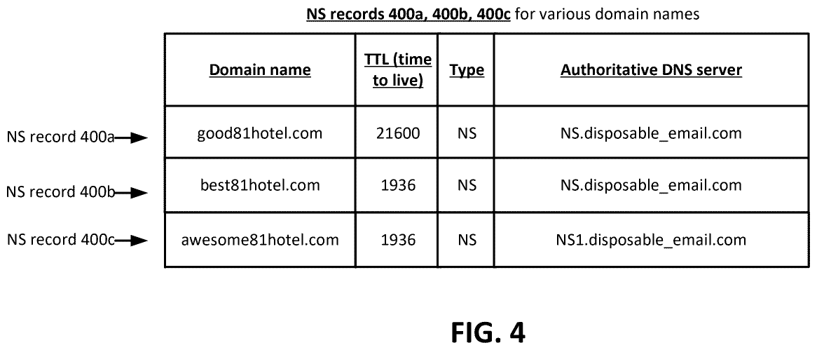

An NS record is another type of DNS record. For a given domain, the NS record identifies a DNS server that is authoritative for that domain. For example, the NS record identifies a server that contains the actual DNS records for a domain. So, NS records tell the Internet where to go to find out an IP address (or a mail server identifier) corresponding to a domain. A domain may have multiple NS records, such as one or more primary and/or one or more secondary nameservers for the domain. FIG. 4 illustrates a plurality of NS records 400a, 400b, 400c for various example domain names. Three NS records are illustrated in three rows of the table of FIG. 4. Note that the disposable email address detection and tracking service 104 may query the DNS server 130 three different instances, to receive the corresponding three NS records. Although the three example NS records are separate from each other and received in three different instances, these records are illustrated in a single table format in FIG. 4 for purposes of ease of identification.

The first column in FIG. 4 represents a domain name. The NS record 400a is for the domain name good81hotel.com. The NS record 400b is for the domain name best81hotel.com. The NS record 400c is for the domain name awesome81hotel.com.

As described above, in an example, all three domains good81hotel.com, best81hotel.com, and awesome81hotel.com are registered to the same disposable email address provider, and/or the same disposable email address provider provides the email addresses associated with these three domains.

Accordingly, in FIG. 4 and merely as examples, the authoritative DNS server names for the domains good81hotel.com and best81hotel.com are the same, which is, also merely as an example, NS.disposable_email.com. However, the disposable email address provider may decide to change the name of the authoritative DNS server for the domain awesome81hotel.com to NS1.disposable_email.com. Accordingly, merely from the NS records 400a, 400b, 400c, it may not be evident that the three domains are operated by the same disposable email address provider.

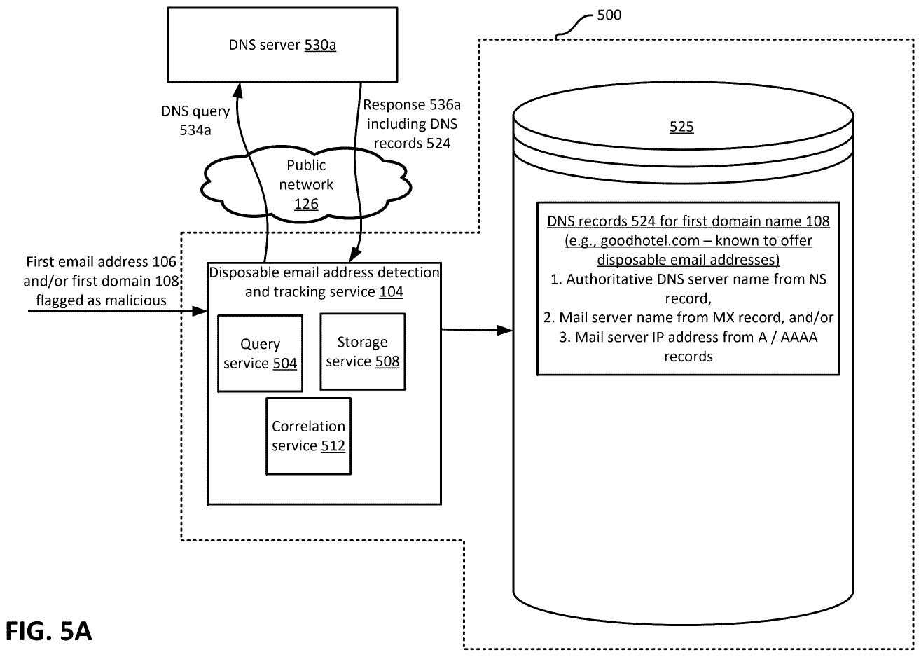

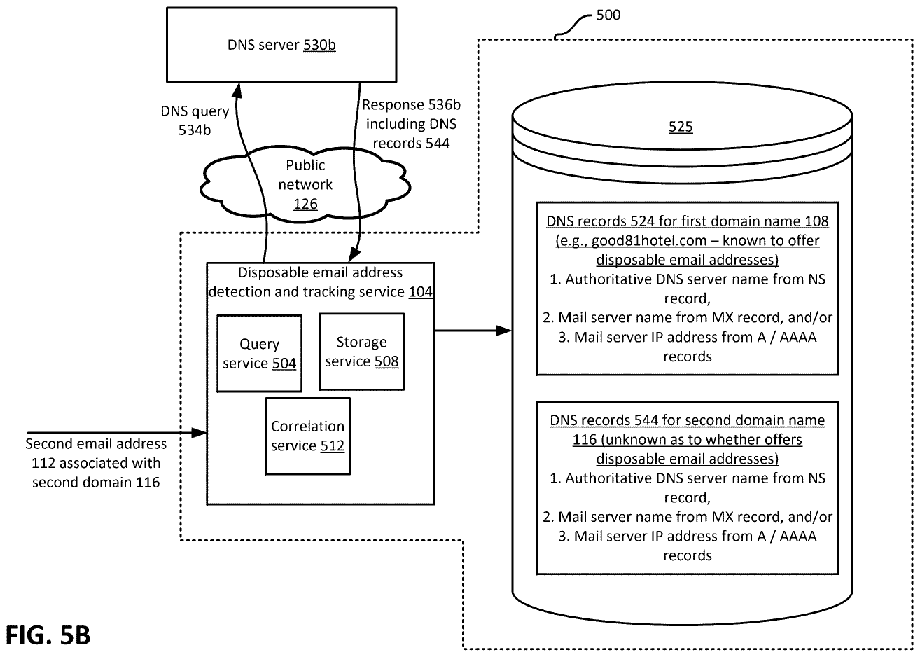

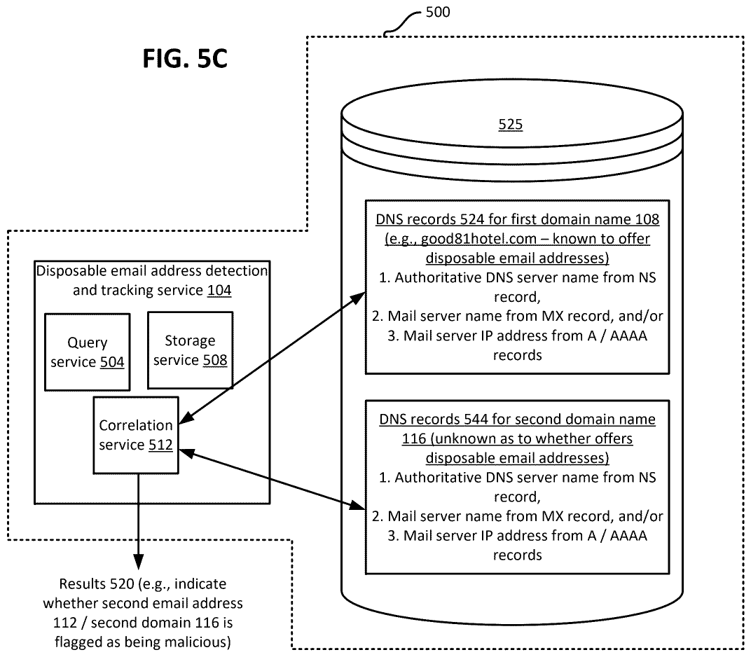

FIGS. 5A, 5B, and 5C illustrate a system 500 that determines whether an email address is a disposable email address, and whether a corresponding domain name is associated with disposable email addresses. In an example, the system 500 includes the disposable email address detection and tracking service 104 of FIG. 1, along with a storage repository 525. For example, FIGS. 5A-5C illustrate operations of the system 500.

Referring to FIG. 5A, the disposable email address detection and tracking service 104 receives a first email from a first email address 106 associated with a first domain 108 that is flagged as malicious. For example, it is known that the first email address 106 is a disposable email address and the first domain 108 is known to be associated with disposable emails. Merely as an example, the first domain 108 may be good81hotel.com and the first email address may be abc@good81hotel.com.

The disposable email address detection and tracking service 104 comprises a query service 504 that may conduct one or more DNS queries. For example, one or more DNS queries 534a for the domain good81hotel.com are routed to an authoritative DNS server 530a associated with the domain good81hotel.com. The query service 504 receives response(s) 536a from the DNS server 530a, where the response(s) 536a include one or more DNS records 524. A storage service 508 of the disposable email address detection and tracking service 104 stores the received DNS records 524 to a storage repository 525 of the system 500.

Merely as an example, the DNS records 524 include, for the first domain 108, one or more of (i) authoritative DNS server name from NS record, (ii) mail server identifier from MX record, and/or (iii) mail server IP address from A or AAAA records. Thus, the DNS records 524 includes a chain of DNS records, such as a NS record, a MX record, and/or a “A” or AAAA record.

Referring now to FIG. 5B, the disposable email address detection and tracking service 104 receives a second email from a second email address 112 associated with a second domain 116. It is yet unknown whether the second email address 112 is a disposable email address, and whether the second domain 116 is known to offer disposable email addresses.

The query service 504 may conduct one or more DNS queries 534b. For example, the DNS queries 534b are routed to a DNS server 530b associated with the second domain 116. In an example, the DNS server 530a of FIG. 5A and the DNS server 530b of FIG. 5B may be the same servers, e.g., if the two domains 108 and 116 are operated by a same disposable email address provider, and the disposable email address provider uses the same authoritative DNS server for both the domains 108 and 116. In another example, the DNS server 530a of FIG. 5A and the DNS server 530b of FIG. 5B may be different servers, e.g., (i) if the two domains 108 and 116 are operated by different email address providers, or (ii) if the two domains 108 and 116 are operated by a same disposable email address provider, and the disposable email address provider uses different authoritative DNS servers for the two domains 108 and 116.

The query service 504 receives response(s) 536b from the DNS server 530b, where the response(s) 536b include one or more DNS records 544. The storage service 508 of the disposable email address detection and tracking service 104 stores the received DNS records 544 to the storage repository 525 of the system 500. Merely as an example, the DNS records 544 include, for the second domain 116, one or more of (i) authoritative DNS server name from NS record, (ii) mail server identifier from MX record, and/or (iii) mail server IP address from A or AAAA records.

Referring now to FIG. 5C, the disposable email address detection and tracking service 104 includes a correlation service 512 that detects whether correlation between the DNS records 524 associated with the first domain 108 and the DNS records 544 associated with the second domain 116 satisfies at least one of a plurality of security criteria. Based on determining whether such a correlation satisfies at least one of a plurality of security criteria, the correlation service 512 outputs a result 520, which indicates whether the second email address 112 and/or second domain 116 are flagged as being malicious. Thus, based on the correlation results, the correlation service 512 may or may not flag the second email address 112 and/or second domain 116 as being malicious. The second email address 112 flagged as being malicious implies that the second email address 112 is likely a disposable email address. The second domain 116 flagged as being malicious implies that the second domain 116 is likely associated with disposable email addresses (e.g., email addresses associated with the second domain 116 are likely to be disposable email addresses).

For example, if the correlation service 512 finds that a correlation between the DNS records 524 and the DNS records 544 satisfies at least one security criterion, the correlation service 512 flags the second email address 112 and/or second domain 116 as being malicious. On the other hand, if the correlation service 512 finds that a correlation between the DNS records 524 and the DNS records 544 does not satisfy any security criteria, the correlation service 512 does not flag the second email address 112 and/or second domain 116 as being malicious. The security criteria may include matching of a domain name, matching of a name of an authoritative DNS server, matching of a name of a mail server, matching of an IP address of a mail server, etc., as will be described below.

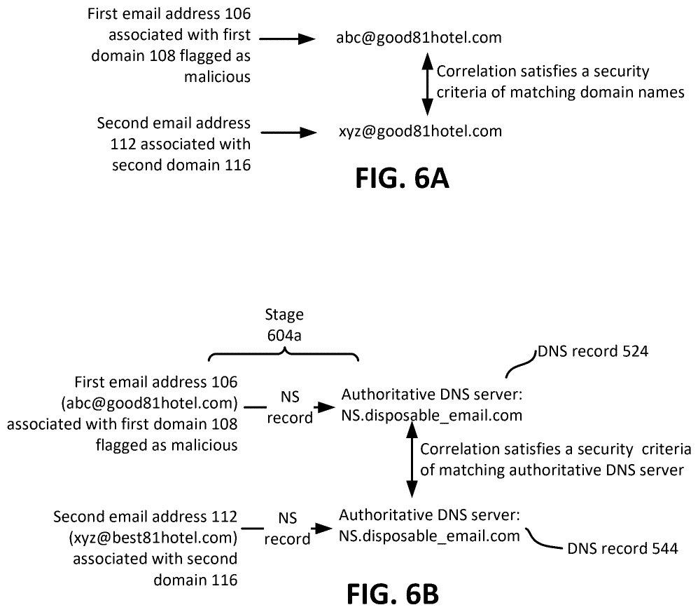

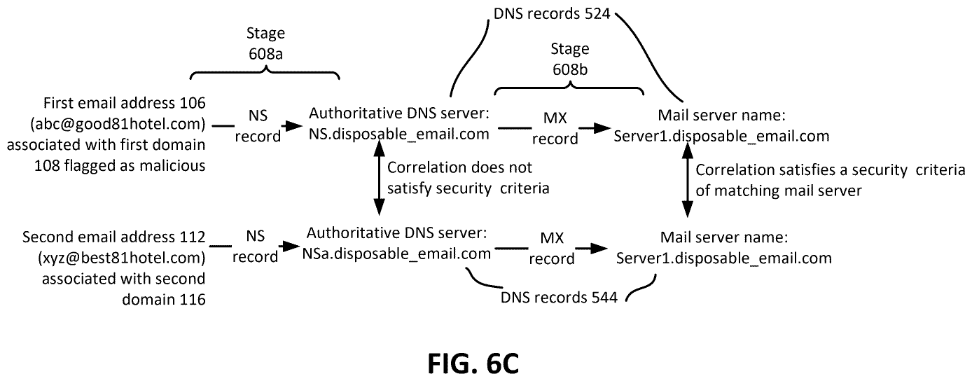

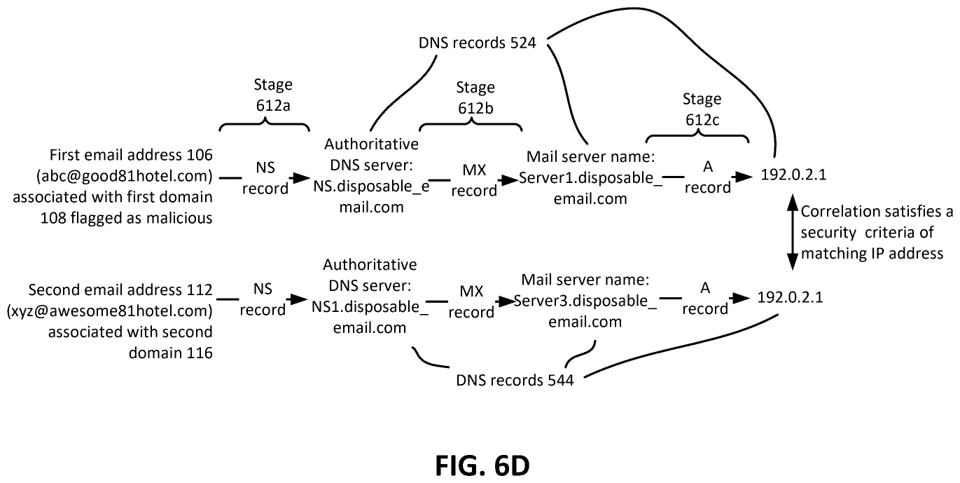

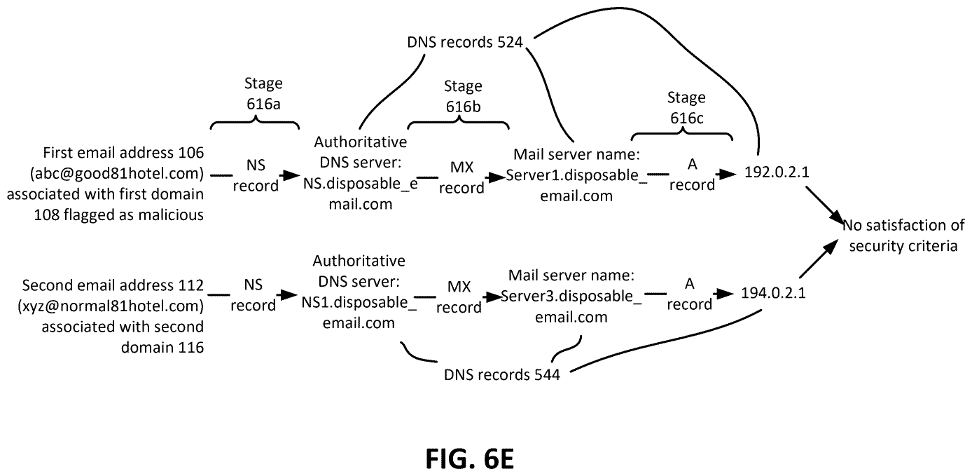

FIGS. 6A, 6B, 6C, 6D, and 6E illustrate correlation examples between (i) first DNS records 524 associated with a first email from a first email address 106 from a first domain 108 and (ii) second DNS records 544 associated with a second email from a second email address 112 from a second domain 116. The DNS records 524 and 544 are stored in the storage repository 525 (see FIGS. 5A and 5B). The correlation service 512 performs the correlation between the DNS records 524 and 544, to see if the correlation satisfies a security criteria.

Referring to FIG. 6A, merely as example, the first email address 106 associated with the first domain 108 (which is flagged as malicious) is abc@good81hotel.com, and the second email address 112 associated with the second domain 116 is xyz@good81hotel.com. This is a simple example in which the first and second emails have the same domain name in their respective email addresses. Accordingly, the correlation service 512 determines that the correlation satisfies a security criteria of matching domain name, and hence, the correlation service 512 flags the second email address 112 associated with the second domain 116 as being malicious. Note that in this example, the first domain 108 and the second domain 116 are the same.

Referring now to FIG. 6B, illustrated is a single stage DNS lookup process in which the DNS records 524 and 544 are determined to have a correlation that satisfies at least one of a plurality of security criteria. For example, there is a single DNS query stage in the example of FIG. 6B. Thus, a first stage 604a of the DNS query is performed in FIG. 6B, where during the first stage 604a, the inputs are the domain names, and the outputs are the corresponding authoritative DNS servers for the domain names.

As illustrated, once an example first email address abc@good81hotel.com and an example second email address xyz@best81hotel.com are received by the disposable email address detection and tracking service 104, the NS record (which maps a domain name to a corresponding authoritative server) for the two email addresses (or the corresponding two domain names good81hotel.com and best81hotel.com) are determined via corresponding DNS queries. For example, the DNS record 524 includes the NS record for the good81hotel.com domain, where the NS record indicates NS.disposable_email.com as the authoritative DNS server for this domain. Similarly, the DNS record 544 includes the NS record for the best81hotel.com domain, where the NS record indicates NS.disposable_email.com as the authoritative DNS server for this domain.

In an example, the correlation service 512 determines that the correlation between the authoritative DNS servers for the two domains are matching, and hence, satisfies a security criteria of matching authoritative DNS servers. Also, it is known that the first email address and the corresponding first domain name are associated with disposable email addresses. Accordingly, the correlation service 512 flags the second email address and the corresponding second domain name as possibly being malicious. For example, the correlation service 512 flags the second email address as possibly being a disposable email address and the corresponding second domain name as possibly being associated with disposable email address.

Referring now to FIG. 6C, illustrated is a two stage DNS lookup process in which the DNS records 524 and 544 are determined to have a correlation that satisfies at least one of a plurality of security criteria. For example, a first stage 608a and a second stage 608b of the DNS query process is iteratively performed in FIG. 6B.

During the first stage 608a, the inputs are the domain names, and the outputs are the corresponding authoritative DNS servers for the domain names (e.g., in the form of NS records). During the second stage 608a, the inputs are the domain names queried to the corresponding authoritative DNS servers, and the outputs are the corresponding mail server identifiers for the domain names (e.g., in the form of MX records).

As illustrated, once an example first email address abc@good81hotel.com and an example second email address xyz@best81hotel.com are received by the disposable email address detection and tracking service 104, the NS records (which maps a domain name to a corresponding authoritative server) for the two email addresses (or the corresponding two domain names good81hotel.com and best81hotel.com) are determined via corresponding DNS queries during the first stage 608a. For example, the DNS record 524 includes the NS record for the good81hotel.com domain, where the NS record indicates NS.disposable_email.com as the authoritative DNS server for this domain. Similarly, the DNS record 544 includes the NS record for the best81hotel.com domain, where the NS record indicates NSa.disposable_email.com as the authoritative DNS server for this domain. Thus, there is a mismatch between the authoritative DNS servers for the two domains.

During the second stage 608b, the authoritative DNS server for the domain good81hotel.com (where the authoritative DNS server is NS.disposable_email.com) is queried about the domain good81hotel.com. The authoritative DNS server outputs a MX record indicating the mail server identifier for this domain good81hotel.com, where the mail server in this example is Server1.disposable_email.com.

Also during the second stage 608b, the authoritative DNS server for the domain best81hotel.com (where the authoritative DNS server is NSa.disposable_email.com) is queried about the domain best81hotel.com. The authoritative DNS server outputs another MX record indicating the mail server identifier for this domain good81hotel.com, where the mail server in this example is also Server1.disposable_email.com

The correlation service 512 determines that the correlation between the mail server identifiers for the two domains good81hotel.com and best81hotel.com are matching, and hence, satisfies a security criteria of matching mail server identifiers. Also, it is known that the first email address and the corresponding first domain name are associated with disposable email addresses. Accordingly, the correlation service 512 flags the second email address and the corresponding second domain name as also possibly being malicious. For example, the correlation service 512 flags the second email address as possibly being a disposable email address and the corresponding second domain name as possibly being associated with disposable email address.

Referring now to FIG. 6D, illustrated is a three stage DNS lookup process in which the DNS records 524 and 544 are determined to have a correlation that satisfies at least one of a plurality of security criteria. For example, a first stage 612a, a second stage 612b, and a third stage 612c of the DNS query process are iteratively performed in FIG. 6C. During the first stage 612a, the inputs are the domain names, and the outputs are the corresponding authoritative DNS servers for the domain names (e.g., in the form of NS records). During the second stage 612a, the inputs are the domain names queried to the corresponding authoritative DNS servers, and the outputs are the corresponding mail server identifiers for the domain names (e.g., in the form of MX records). During the third stage 612c, the inputs are the mail server identifiers queried to the corresponding authoritative DNS servers, and the outputs are the corresponding IP addresses of the mail servers (e.g., in the form of “A” or AAAA records).

As illustrated, once an example first email address abc@good81hotel.com and an example second email address xyz@awesome81hotel.com is received by the disposable email address detection and tracking service 104, the NS records (which maps a domain name to a corresponding authoritative server) for the two email addresses (or the corresponding two domain names good81hotel. com and awesome81hotel.com) are determined via corresponding DNS queries during the first stage 612a. For example, the DNS record 524 includes the NS record for the good81hotel.com domain, where the NS record indicates NS.disposable_email.com as the authoritative DNS server for this domain. Similarly, the DNS record 544 includes the NS record for the awesome81hotel.com domain, where the NS record indicates NS1.disposable_email.com as the authoritative DNS server for this domain. Thus, there is a mismatch between the authoritative DNS servers for the two domains.

During the second stage 612b, the authoritative DNS server for the domain good81hotel.com (where the authoritative DNS server is NS.disposable_email.com) is queried about the domain good81hotel.com. The authoritative DNS server outputs a MX record indicating the mail server identifier for this domain good81hotel.com, where the mail server in this example is Server1.disposable_email.com.

Also during the second stage 612b, the authoritative DNS server for the domain awesome81hotel.com (where the authoritative DNS server is NS1.disposable_email.com) is queried about the domain awesome81hotel.com. The authoritative DNS server outputs another MX record indicating the mail server identifier for this domain awesome81hotel.com, where the mail server in this example is also Server3.disposable_email.com. Thus, there is a mismatch between the mail server identifiers for the two domains.

During the third stage 612c, the authoritative DNS server for the domain good81hotel.com (where the authoritative DNS server is NS.disposable_email.com) is queried about the mail server Server1.disposable_email.com for the domain good81hotel.com. The authoritative DNS server outputs an A or AAAA record indicating the mail server for this domain good 81hotel.com has an IP address of 192.0.2.1, where the mail server in this example is Server1.disposable_email.com.

Also during the third stage 612c, the authoritative DNS server for the domain awesome81hotel.com (where the authoritative DNS server is NS1.disposable_email.com) is queried about the mail server Server3.disposable_email.com for the domain awesome81hotel.com. The authoritative DNS server outputs an A or AAAA record indicating the mail server for this domain awesome 81hotel.com has an IP address of 192.0.2.1, where the mail server in this example is Server3.disposable_email.com.

The correlation service 512 determines that the the IP addresses of the mail servers for the two domains good81hotel.com and awesome81hotel.com are matching, and hence, the correlation between the two DNS records 524 and 544 satisfies a security criteria of matching mail server IP addresses. Also, it is known that the first email address and the corresponding domain name are associated with disposable email addresses. Accordingly, the correlation service 512 flags the second email address and the corresponding second domain name as possibly being malicious. For example, the correlation service 512 flags the second email address as possibly being a disposable email address and the corresponding second domain name as possibly being associated with disposable email address.

Referring now to FIG. 6E, illustrated is another three stage DNS lookup process in which the DNS records 524 and 544 are determined to have a correlation that fails to satisfy any of a plurality of security criteria. For example, a first stage 616a, a second stage 616b, and a third stage 616c of the DNS query process is iteratively performed in FIG. 6E. During the first stage 616a, the inputs are the domain names, and the outputs are the corresponding authoritative DNS servers for the domain names (e.g., in the form of NS records). During the second stage 616a, the inputs are the domain names queried to the corresponding authoritative DNS servers, and the outputs are the corresponding mail server identifiers for the domain names (e.g., in the form of MX records). During the third stage 616c, the inputs are the mail server identifiers queried to the corresponding authoritative DNS servers, and the outputs are the corresponding IP addresses of the mail servers (e.g., in the form of A pr AAAA records). As illustrated in FIG. 6E, there is no matching between the NS records of the two domain names, no matching between the MX records of the two domain names, and no matching between the A or AAAA records of the two domain names.

Accordingly, the correlation service 512 determines that the correlation between the DNS records for the two domain names in the example of FIG. 6E does not satisfy any security criteria. Thus, the two domains of FIG. 6E are unlikely to be registered to or operated by the same disposable email address provider. Accordingly, the correlation service 512 refrains from flagging the second email address and the second domain as possibly being malicious.

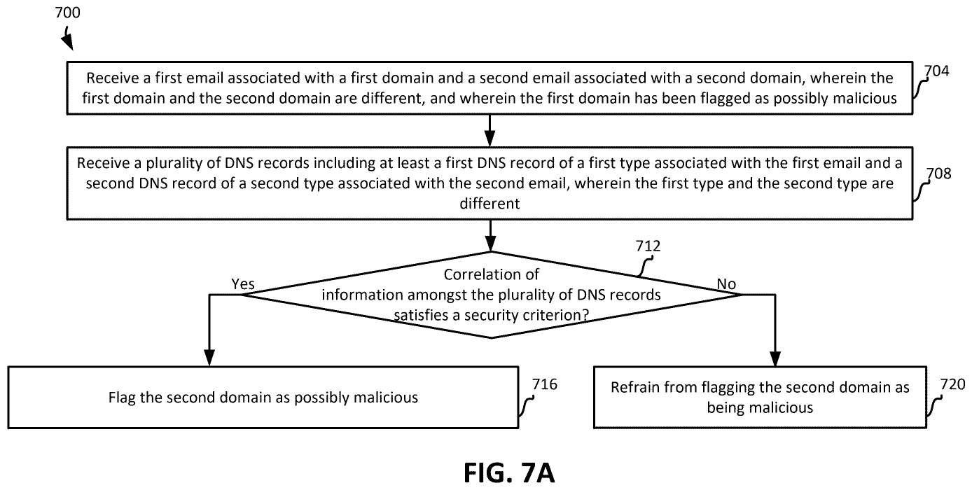

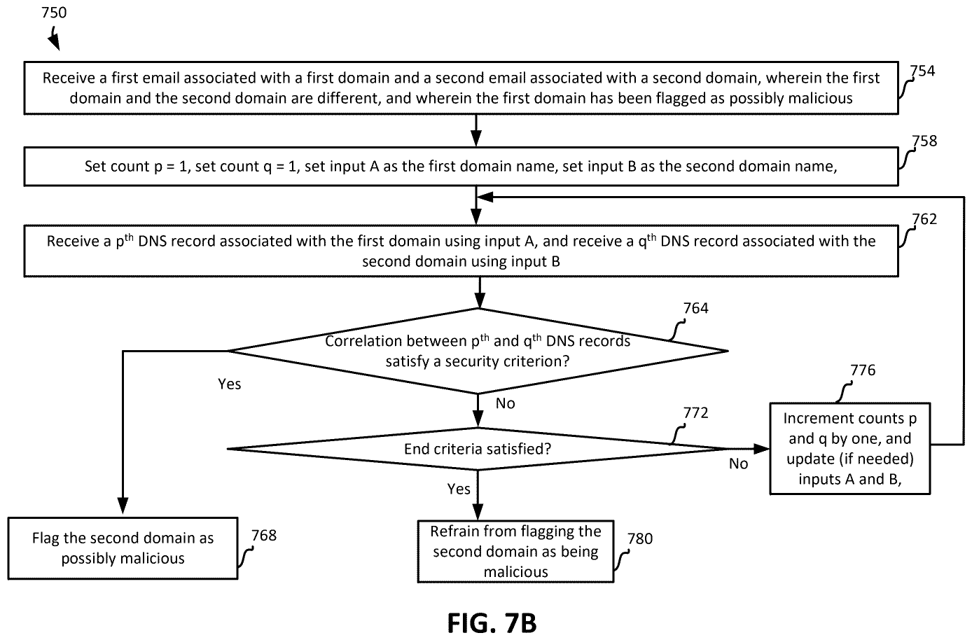

FIG. 7A illustrates a flowchart depicting a method 700 for determining whether an email address is likely to be a disposable email address and whether an email domain offers disposable email addresses. Various processes of the method 700 may be implemented by the disposable email address detection and tracking service 104 of the system 500 discussed above.

At 704, a first email associated with a first email address of a first domain and a second email associated with a second email address of a second domain are received (e.g., by the disposable email address detection and tracking service 104). In an example, the first domain and the second domain are different, and wherein the first domain has been previously flagged as possibly malicious, e.g., as described above with respect to FIGS. 6B-6E.

At 708, a plurality of DNS records associated with the first domain and the second domain are received (e.g., by the query service 504 of the disposable email address detection and tracking service 104). In an example, the plurality of DNS records includes at least a first DNS record of a first type associated with the first email and a second DNS record of a second type associated with the second email, wherein the first type and the second type are different. For example, the first DNS record may be one of a NS record, a MX record, and an A or AAAA record, and the second DNS record may be another of a NS record, a MX record, and an A or AAAA record. The first DNS record is associated with the first domain, and the second DNS record is associated with the second domain.

Also at 712, the plurality of DNS records are analyzed, e.g., by the correlation service 512 of the disposable email address detection and tracking service 104. For example, the correlation service 512 determines whether correlation of information amongst the plurality of DNS records satisfies a security criterion. For example, as described above with respect to each of FIGS. 6B-6D, the correlation of information amongst the plurality of DNS records 524 and 544 satisfies a security criterion. On the other hand, as described above with respect to FIG. 6E, the correlation of information amongst the plurality of DNS records 524 and 544 does not satisfy a security criteria.

In an example, a correlation score may be assigned. For example, if correlation of information amongst the plurality of DNS records satisfies the security criterion, a high correlation score (e.g., higher than a threshold) is assigned to the second domain. On the other hand, if correlation of information amongst the plurality of DNS records does not satisfy the security criterion, a low correlation score (e.g., lower than a threshold) is assigned to the second domain.

If “Yes” at 712 (e.g., correlation of information amongst the plurality of DNS records satisfies a security criterion, and/or if the correlation score is higher than the threshold), the method 700 proceeds from 712 to 716, where the second domain is flagged (e.g., by the correlation service 512 of the disposable email address detection and tracking service 104) as possibly malicious, e.g., as described above with respect to FIGS. 6B-6D.

On the other hand, if “No” at 712 (e.g., correlation of information amongst the plurality of DNS records does not satisfy any security criteria, and/or if the correlation score is lower than the threshold), the method 700 proceeds from 712 to 720, where the second domain is not flagged (e.g., by the correlation service 512 of the disposable email address detection and tracking service 104) as possibly malicious, e.g., as described above with respect to FIG. 6E. Thus, at 720, the second domain and consequently the second email are not flagged as possibly malicious. Accordingly, in this scenario, a user associated with the second email is granted access to one or more services. Thus, because the second email address is not likely malicious, a user of the second email is granted access to services that a regular user with a non-disposable email address would normally be provided with.

In contrast, at 716, the second domain and consequently the second email are flagged as possibly malicious. Accordingly, in this scenario, a user associated with the second email is denied access to one or more services. Thus, because the second email address is likely malicious, a user of the second email is denied access to services that a regular user with a non-disposable email address would normally be provided with.

FIG. 7B illustrates another flowchart depicting another method 750 for determining whether an email address is likely to be a disposable email address and whether an email domain offers disposable email addresses. Various processes of the method 700 may be implemented by the disposable email address detection and tracking service 104 of the system 500 discussed above. The method 750 illustrates a more detailed implementation of detection and tracking of disposable email addresses and corresponding domains.

At 754, a first email associated with a first email address of a first domain and a second email associated with a second email address of a second domain are received (e.g., by the disposable email address detection and tracking service 104). In an example, the first domain and the second domain are different, and the first domain has been previously flagged as possibly malicious, e.g., as described above with respect to FIGS. 6A-6E.

At 758, a count p is set to 1, and another count q is set to 1. Also, an input A is set to the first domain name, and an input B is set to the second domain name.

At 762, a p^{th} DNS record associated with the first domain is received using the input A, and a q^{th} DNS record associated with the second domain is received using the input B. Merely as an example, the process 762 may be performed iteratively or in a loop. During a first iteration of process 762, the input A is set to the first domain name, and the input B is set to the second domain name. Also, during the first iteration of 762 (e.g., p=q=1), the p^{th} DNS record and the q^{th} DNS record may respectively be the NS records for the first and second domains. The outputs of the p^{th} DNS record and the q^{th} DNS record are the authoritative servers of the first and second domains, respectively.

The method 700 proceeds from 762 to 764. At 764, a determination is made as to whether correlation between the p^{th} and the q^{th} DNS records satisfy a security criterion. For example, during the first iteration of the process 764, the determination is made as to whether outputs of the p^{th} and the q^{th} DNS records (which are NS records) are matching, such as matching authoritative server names of the first and second domains.

If “Yes” at 764 (e.g., as described above with respect to FIG. 6B), the method 750 proceeds to 768, where the second domain is flagged (e.g., by the correlation service 512 of the disposable email address detection and tracking service 104) as possibly malicious.

On the other hand, if “No” at 764 (e.g., as described above with respect to FIGS. 6C-6E), the method 750 proceeds to 772, where a determination is made as to whether an end criterion for the iterations of the processes 762, . . . , 776 of the method 750 is satisfied. Merely as an example, an end criterion may be the counts p and q. For example, the processes 762, . . . , 776 may be iterated at most a threshold number of times (such as 3 times or 4 times), and hence, if p and/or q reach this threshold number, the end criterion is satisfied.

In another example, an end criterion may be based on the outputs of the p^{th} and the q^{th} DNS records. For example, if the outputs of the p^{th} and the q^{th} DNS records are IP addresses, the end criterion is satisfied. Thus, in this example, the process 762 may be iterated until the p^{th} and the q^{th} DNS records are “A” or AAAA records, having corresponding IP addresses as their outputs.

If “Yes” at 772, then the end criterion is satisfied, and the method 750 proceeds to 780. This implies that even after sufficient number of iterations of the process 762, correlation between the DNS records associated with the first domain and the DNS records associated with the second domain does not satisfy any of a plurality of security criteria, e.g., as described above with respect to FIG. 6E. Accordingly, at 780, the second domain is not flagged (e.g., by the correlation service 512 of the disposable email address detection and tracking service 104) as possibly malicious, e.g., as also described above with respect to FIG. 6E.

On the other hand, if “No” at 772, then the end criterion is not satisfied, and the method 750 proceeds to 776 (e.g., the process 776 may be iterated once more). At 776, the counts p and q are incremented by one, and the inputs A and B are selectively updated (e.g., if needed). For example, the counts p and q are incremented by one, while entering the next iteration of the above-described iterative processes. Note that the various iterations of the process 762 correspond to the various stages 604a, 608a, 608b, 612a, . . . , 616c of FIGS. 6B-6E.

Also, during the second iteration of the process 762, for each of the first and second domains, a corresponding MX record may be fetched from a corresponding authoritative DNS server, where the identification of the authoritative DNS server may have been received from the NS record during the first iteration of the process 762. Accordingly, the inputs for fetching the MX records are still the domain names, and hence, inputs A and B remain the domain names of the first and second domains, respectively. Also, during the second iteration of the process 762, the p^{th} and the q^{th} DNS records are MX records, having corresponding mail server identifiers as their outputs.

If the method 750 proceeds from the second iteration of 762 to 764 and 772 and the end criteria is still not satisfied, the method 750 again proceeds to 776. Now p and q are incremented to 3. Also, the inputs A and B are updated to the mail server identifiers (which were outputs of the second DNS records from the second iteration of the process 762). Accordingly, during the third iteration of the process 762, the inputs A and B are the mail server identifiers for the first domain and the second domain, respectively. The 3^{rd} DNS records are the “A” or AAAA records of the first and second domains, and the outputs are the IP addresses of the mail servers of the first and second domains.

This method 750 is thus iteratively performed, until the method 750 reaches either process 768 (where the second domain is flagged as malicious) or process 780 (where the second domain is not flagged as malicious).

Note that in an example, the disposable email detection and tracking service 104 may be implemented using a machine learning (ML) model. For example, the ML model receives the first and second domain names, and queries and fetches DNS records associated with the first and second domain names. The ML model may be trained to determine whether correlation among the DNS records associated with the first and second domain names satisfy the above described one or more security criteria, based on which the ML model may or may not flag the second domain as being malicious.

### COMPUTER SYSTEM ARCHITECTURE

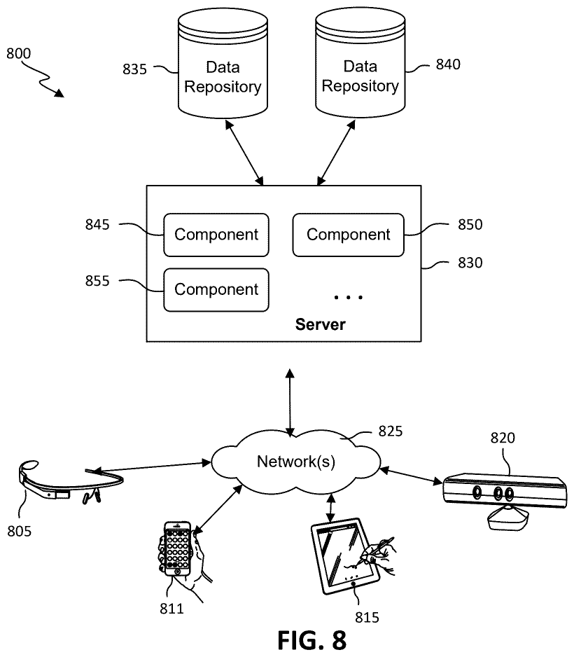

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for detecting and tracking disposable email addresses, and domains associated with disposable email addresses.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for detecting and tracking disposable email addresses, and domains associated with disposable email addresses, in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for detecting and tracking disposable email addresses, and domains associated with disposable email addresses. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

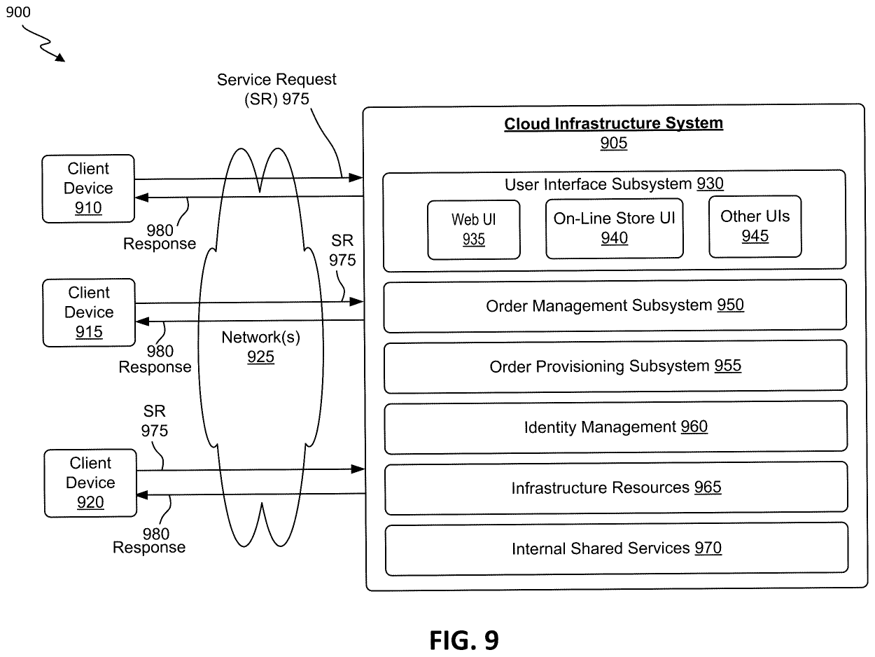

FIG. 9 is a simplified block diagram of a cloud-based system environment in which techniques are disclosed for detecting and tracking disposable email addresses, and domains associated with disposable email addresses, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise a service management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the service provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

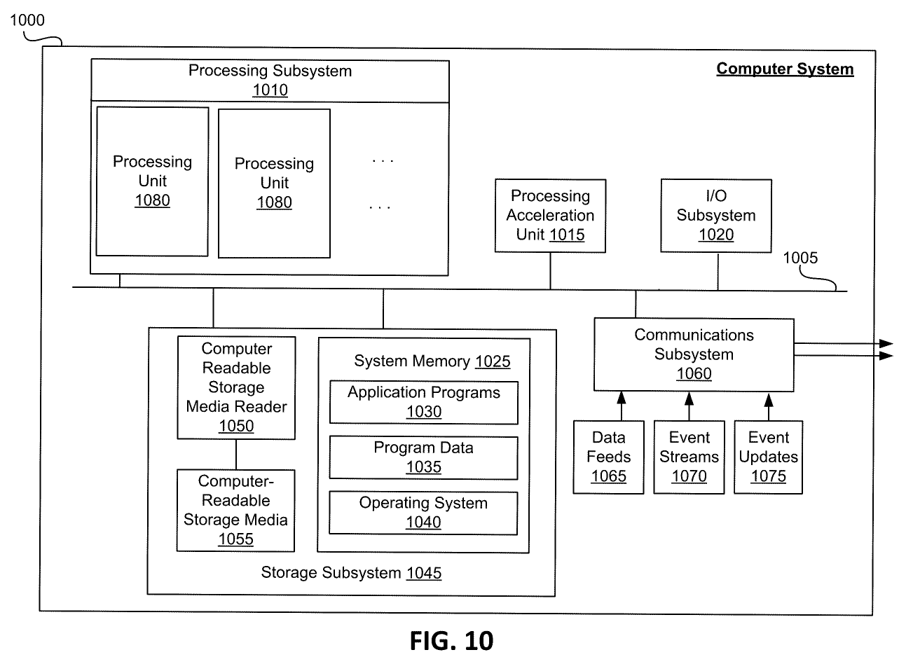

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory and/or transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
receiving a first email associated with a first domain and a second email associated with a second domain, wherein the first domain and the second domain are different;
performing an analysis on a plurality of DNS (domain name system) records comprising at least a first DNS record of a first type associated with the first email and a second DNS record of a second type associated with the second email, wherein the first type and the second type are different;
based on the analysis, determining whether a correlation of information amongst the plurality of DNS records satisfies a security criterion; and
responsive to (1) determining that the first domain has been flagged as malicious and (2) determining that the correlation of information amongst the plurality of DNS records satisfies the security criterion, flagging the second domain as malicious.

2. The non-transitory computer-readable medium of claim 1, wherein:
each of the plurality of DNS records comprises a mapping between a respective input data and a respective output data;
the output data of the first DNS record of the first type comprises a first Internet Protocol (IP) address;
the output data of the second DNS record of the second type does not comprise any IP address;
the operations further comprise identifying the plurality of DNS records for analysis, wherein identifying the plurality of DNS records comprises:
setting the second domain name as a current input data;
iteratively performing:
identifying a DNS record, from the plurality of DNS records, that has a respective input data matching the current input data;
identifying a respective output data corresponding to the respective input data based on the DNS record; and
setting the respective output data as the current input data, until the respective output data comprises a second IP address; and
determining whether the correlation of information amongst the plurality of DNS records satisfies the security criterion comprises: determining whether the first IP address and the second IP address match.

3. The non-transitory computer-readable medium of claim 1, wherein:
each of the plurality of DNS records comprises a mapping between a respective input data and a respective output data;
the output data of the first DNS record of the first type comprises a first mail server identifier;
the output data of the second DNS record of the second type does not comprise any mail server identifier;
the operations further comprise identifying the plurality of DNS records for analysis, wherein identifying the plurality of DNS records comprises:
setting the second domain name as a current input data;
iteratively performing:
identifying a DNS record, from the plurality of DNS records, that has a respective input data matching the current input data;
identifying a respective output data corresponding to the respective input data based on the DNS record; and
setting the respective output data as the current input data, until the respective output data comprises a second mail server identifier; and
determining whether the correlation of information amongst the plurality of DNS records satisfies the security criterion comprises: determining whether the first mail server identifier and the second mail server identifier match.

4. The non-transitory computer-readable medium of claim 1, wherein:
the first DNS record of the first type comprises a first MX record identifying a first mail server identifier associated with the first domain, wherein the first mail server is associated with a first Internet Protocol (IP) address;
the second DNS record of the second type comprises a first A record or a first AAAA record identifying a second IP address associated with a second mail server identifier that is associated with the second domain; and
determining that the correlation of information amongst at least the first DNS record and the second DNS record satisfies the security criterion is responsive at least to determining that the first IP address and the second IP address match.

5. The non-transitory computer-readable medium of claim 1, wherein:
each of the plurality of DNS records comprises a mapping between a respective input data and a respective output data;
the operations further comprise identifying the plurality of DNS records for analysis, wherein identifying the plurality of DNS comprises:
setting the first domain name as a current input data;
iteratively performing, until an end criterion is satisfied:
identifying a DNS record, from the plurality of DNS records, that has a respective input data matching the current input data;
identifying a respective output data corresponding to the respective input data based on the DNS record;
setting the respective output data as the current input data;
determining whether the correlation of information amongst the plurality of DNS records satisfies the security criterion comprises: calculating a correlation score for the plurality of DNS records.

6. The non-transitory computer-readable medium of claim 5, wherein the end criterion comprises the respective output data corresponding to the respective input data based on the DNS record being an internet protocol (IP) address.

7. The non-transitory computer-readable medium of claim 5, wherein the end criterion comprises iteratively performing for at least a threshold number of times.

8. The non-transitory computer-readable medium of claim 1, wherein determining whether the correlation of information amongst the plurality of DNS records satisfies the security criterion comprises: applying a machine-learning model to the plurality of DNS records to determine whether the security criterion is satisfied.

9. The non-transitory computer-readable medium of claim 1, wherein:
the first DNS record of the first type comprises one of an A record, an AAAA record, a MX record (mail exchanger record), and a NS (nameserver) record; and
the second DNS record of the second type comprises another of the A record, the AAAA record, the MX record, and the NS record.

10. The non-transitory computer-readable medium of claim 1, wherein the security criterion comprises a correlation score for the plurality of DNS records being above a threshold score.

11. The non-transitory computer-readable medium of claim 1, wherein a malicious flag on the second domain indicates that the second domain is likely used for disposable email addresses.

12. The non-transitory computer-readable medium of claim 1, wherein the operations further include:
granting access to one or more services to a first user associated a third email associated with a third domain that has not been flagged as malicious; and
denying the one or more services to a second user associated with the second email associated with the second domain based at least on flagging that the second domain as malicious.

13. A method comprising:
receiving a first email associated with a first domain and a second email associated with a second domain, wherein the first domain and the second domain are different;
performing an analysis on a plurality of DNS (domain name system) records comprising at least a first DNS record of a first type associated with the first email and a second DNS record of a second type associated with the second email, wherein the first type and the second type are different;
based on the analysis, determining whether a correlation of information amongst the plurality of DNS records satisfies a security criterion; and
responsive to (1) determining that the first domain has been flagged as malicious and (2) determining that the correlation of information amongst the plurality of DNS records satisfies the security criterion, flagging the second domain as malicious.

14. The method of claim 13, wherein:
each of the plurality of DNS records comprises a mapping between a respective input data and a respective output data;
the output data of the first DNS record of the first type comprises a first Internet Protocol (IP) address;
the output data of the second DNS record of the second type does not comprise any IP address;
the method further comprises identifying the plurality of DNS records for analysis, wherein identifying the plurality of DNS records comprises:
setting the second domain name as a current input data;
iteratively performing:
identifying a DNS record, from the plurality of DNS records, that has a respective input data matching the current input data;
identifying a respective output data corresponding to the respective input data based on the DNS record; and
setting the respective output data as the current input data, until the respective output data comprises a second IP address; and
determining whether the correlation of information amongst the plurality of DNS records satisfies the security criterion comprises: determining whether the first IP address and the second IP address match.

15. The method of claim 13, wherein:
each of the plurality of DNS records comprises a mapping between a respective input data and a respective output data;
the output data of the first DNS record of the first type comprises a first mail server identifier;
the output data of the second DNS record of the second type does not comprise any mail server identifier;
the method further comprises identifying the plurality of DNS records for analysis, wherein identifying the plurality of DNS records comprises:
setting the second domain name as a current input data;
iteratively performing:
identifying a DNS record, from the plurality of DNS records, that has a respective input data matching the current input data;
identifying a respective output data corresponding to the respective input data based on the DNS record; and
setting the respective output data as the current input data, until the respective output data comprises a second mail server identifier; and
determining whether the correlation of information amongst the plurality of DNS records satisfies the security criterion comprises: determining whether the first mail server identifier and the second mail server identifier match.

16. The method of claim 13, wherein:
the first DNS record of the first type comprises a first MX record identifying a first mail server identifier associated with the first domain, wherein the first mail server is associated with a first Internet Protocol (IP) address;
the second DNS record of the second type comprises a first A record or a first AAAA record identifying a second IP address associated with a second mail server identifier that is associated with the second domain; and
determining that the correlation of information amongst at least the first DNS record and the second DNS record satisfies the security criterion is responsive at least to determining that the first IP address and the second IP address match.

17. The method of claim 13, wherein:
the first DNS record of the first type comprises one of an A record, an AAAA record, a MX record (mail exchanger record), and a NS (nameserver) record; and
the second DNS record of the second type comprises another of the A record, the AAAA record, the MX record, and the NS record.

18. The method of claim 13, further comprising:
granting access to one or more services to a first user associated a third email associated with a third domain that has not been flagged as malicious; and
denying the one or more services to a second user associated with the second email associated with the second domain based at least on flagging that the second domain as malicious.

19. A system comprising:
one or more processors; and
one or more non-transitory computer-readable media storing instructions, which, when executed by the system, cause the system to perform a set of actions including:
receiving a first email associated with a first domain and a second email associated with a second domain, wherein the first domain and the second domain are different;
performing an analysis on a plurality of DNS (domain name system) records comprising at least a first DNS record of a first type associated with the first email and a second DNS record of a second type associated with the second email, wherein the first type and the second type are different;
based on the analysis, determining whether a correlation of information amongst the plurality of DNS records satisfies a security criterion; and
responsive to (1) determining that the first domain has been flagged as malicious and (2) determining that the correlation of information amongst the plurality of DNS records satisfies the security criterion, flagging the second domain as malicious.

20. The system of claim 19, wherein a malicious flag on the second domain indicates that the second domain is likely used for disposable email addresses.
